(19) United States
(12) Patent Application Publication
(10) Pub. No.: US 2007/0237617 A1
(43) Pub. Date: Oct. 11, 2007

(54) Linkage for on-off loading and dumping of a body on a truck frame

(75) Inventor: Matthew Wendell Schroeder, Ventura, IA (US)

Correspondence Address: G. BRIAN PINGEL, BROWN, WINICK, GRAVES,;GROSS, BASKERVILLE AND SCHOENEBAUM, P.L.C., REGENCY WEST 5, 4500 WESTOWN PARKWAY, SUITE 277, WEST DES MOINES, IA, 50266, US

(73) Assignee: Stellar Industries, Inc.

(21) Appl. No.: 11/397,404

(22) Filed: Apr. 5, 2006

(51) Int. Cl. B65F 3/26

(52) U.S. Cl. 414/491

(57) ABSTRACT

Damage to a linkage in a truck loading mechanism including a tilt link, a secondary link and a dump link is avoided by providing interlocking tabs where one of the tabs is slidably and pivotally mounted to the dump link and normally held in an operative position by means of a spring that allows downward and inward movement of one of the interlocking tabs before damage can occur when excessive forces exist between the links.

### FIELD OF THE INVENTION

This invention relates to on-off loading and dumping linkages for load receiving bodies carried on a truck frame.

### BACKGROUND OF RELATED ART

U.S. Pat. No. 5,108,247, issued Apr. 28, 1992, entitled “Loading Linkage” and assigned to the same assignee as the instant application, the entire disclosure of which is herein incorporated by reference, discloses a loading linkage that is multi-functional and which is intended to be mounted on the frame of a body hauling truck. The linkage provides for on loading or off loading the body to the truck frame as well as a dumping mode wherein the contents of the body may be dumped while still attached to the truck. This linkage has been in commercial use for a goodly number of years and has been very successful in the applications for which it is intended. The linkage includes a secondary link and a tilt link pivoted to the frame and which extend under and up the front of a body on the truck. A dump link is also provided and extends under the body and is pivoted to the rear of the truck frame. A first power cylinder pivotally engages the secondary link for tilting the secondary link relative to the truck frame and a second power cylinder is provided for pivoting the tilt link relative to the secondary link.

The tilt link, adjacent the dump link, has a locking tab that underlies a similar tab on the dump link in one position so as to lock all of the links for movement in unison under power from the first cylinder to effectuate a dumping mode. In addition, the tilt link may be tilted relative to the secondary link under the power of the second power cylinder to remove the tab from a position underlying the dump link to disconnect the dump link from the remaining links, thus allowing movement of the tilt and secondary links without movement of the dump link under power from the first cylinder to effectuate the on-off loading mode.

Typically, the tilt link has a hook at its end remote from the secondary link which is engageable with a grab bar mounted on the front wall of the body. The hook, when engaged with the grab bar, provides the necessary engagement with the body to provide on-off loading of the body on the truck as well as to hold the body in place during the dumping mode.

Proper operation of the linkage requires that when on loading a body, the operator should totally retract the first power cylinder before retracting the second power cylinder. If this order of operation is not followed and the second power cylinder is retracted before the first power cylinder, the tilt tab and dump tab at the interface of the tilt link and the dump link may not properly align with the tab on the tilt link coming down on top of the tab on the dump link, rather than underlying the same as is intended. The result may cause damage to the tilt or secondary links.

U.S. Pat. No. 6,749,389, issued Jun. 15, 2004, entitled “Linkage for on-off Loading and Dumping of a Dumpster on a Truck Frame” and assigned to the same assignee as the instant application, the entire disclosure of which is herein incorporated by reference, sought to avoid damaging the tilt or secondary links by use of a frangible element used to hold one of the tilt and dump tabs to one of the tilt and dump links. The frangible element in conjunction with a pivot at one of the tilt and dump tabs would allow for the avoidance of damage by breaking and letting one of the tilt and dump tabs to move out of the way of the other tab. Though the frangible element may be inexpensive to replace, it must be replaced after every improper linkage in order to properly secure the tilt and dump tab.

The present invention is directed to obviating the possibility of such damage when linkage is improperly operated without the use of a frangible element that must be replace ever time such possibility of damage is obviated.

### SUMMARY OF THE INVENTION

It is the principal object of the invention to provide an improved multi-function linkage for use on a truck that may be operated in an on-off loading mode for loading or unloading a body on the truck and which may additionally be operated in a dumping mode for dumping the contents of a body while the body is secured to the truck. More specifically, it is an object of the invention to provide such a linkage wherein the possibility of damage to one or more links of the system is obviated even when the linkage is improperly operated.

In one exemplary embodiment, the invention contemplates a truck frame of a body hauling truck that provides on-off loading and dumping modes which includes a dump link pivoted to the truck frame, a secondary link pivoted to the dump link and a tilt link pivoted to the secondary link to extend under and up the front of a body. A first extendable dump motor is provided for pivoting the secondary link relative to the truck frame and a second extendable motor is provided for pivoting the tilt link relative to the secondary link. Interengageable tabs, one on the tilt link and one on the dump link, are provided to connect all of the links for movement in unison under power from the first extendable motor to effectuate the dumping mode. The invention contemplates the improvement wherein one of the tabs is pivotally and slidably mounted to one of the tilt and dump links and further includes an spring element to normally hold the one tab in proper position but allows pivotal and slidable movement when the one tab is subjected to excessive force. The spring is a further improvement in that it resets the tab for proper linkage.

A preferred embodiment contemplates the provision of a pivot pin connecting the one tab to the one of the tilt and dump links and an elongated opening defined by the tub fixed to the one tab of greater size than the pivot pin. The pivot pin extends through the elongated opening. A hook is attached to the tube opposite the one tab and pivot pin for attachment of one end of the spring. It is preferred to have a bolt for attachment of another end of the spring at the end of one of the tilt and dump links.

A further improvement contemplated by the invention is a sensor that senses excessive force on the one tab to alert that linkage must be reattempted. In the preferred embodiment the sensor secured by a nut in a bore in the one tab spaced from the tube.

Other objects and advantages will become apparent from the following specification taken in connection with the accompanying drawings.

### BRIEF DESCRIPTION OF THE DRAWINGS

FIG. 1 is a perspective view of a body hauling truck having a loading linkage embodying the features of the present invention;

FIG. 2 is a fragmentary side elevation of the truck shown in FIG. 1 with a tilt link in dotted lines rotated to an on-off loading mode;

FIG. 3 is an enlarged, fragmentary view of the locking portions on the tilt link and a dump link of the loading linkage shown in FIG. 1;

FIG. 4 is a fragmentary side elevation of the truck with the tilt link and a secondary link rotated in an on-off loading mode;

FIG. 5 is a fragmentary side elevation of the truck with the tilt link and the secondary link and the dump link rotated in unison in a dumping mode;

FIG. 6 is a fragmentary view of the locking portions on the tilt link and the dump link of the loading linkage showing the relative position of the locking components where the second power cylinder has been fully retracted before full retraction of the first power cylinder employed with the linkage;

FIG. 7 is a perspective view of a breakaway tab construction employed in the improvement of the present invention; and

FIG. 8 is a perspective view of the proper positioning of the locking components.

### DETAILED DESCRIPTION OF THE PREFERRED EMBODIMENT

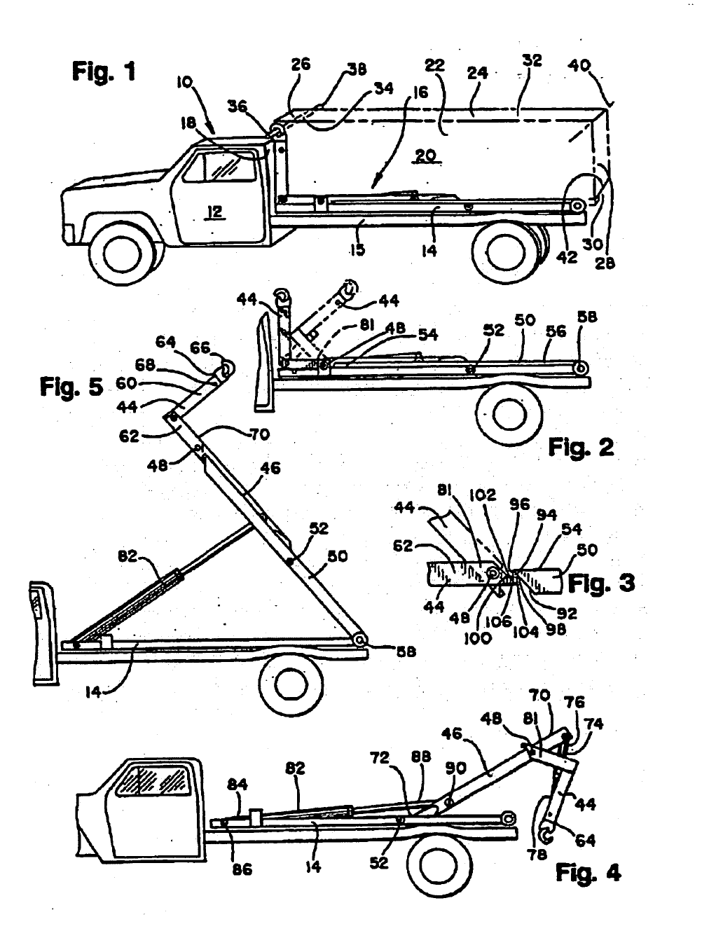

FIG. 1 illustrates a truck generally at 10 having a forward portion or cab 12 and a rearwardly extending bed or frame 14 supported on frame rails 15, only one of which is shown. A linkage embodying the features of the present invention is shown generally at 16 and is supported on the frame 14 and in proximity to a rear face 18 of the cab 12 to carry a rectangular dumpster or load receiving body shown in phantom lines at 20. The body 20 has a pair of laterally spaced sidewalls 22 and 24 extending between opposite end walls 26 and 28. A bottom wall 30 is supported on the linkage 16 and is opposite an open top 32. A grab bar 34 is mounted on the front wall 26 of body 20 and has a pair of oppositely spaced laterally extending ends 36 and 38 which may be engaged with the linkage 16.

The rear wall 28, in one mode, is defined by a pivoting door having a hinge shown schematically at 40 and a locking pin shown schematically at 42 for securing the door.

It should be understood that while a single linkage 16 is illustrated in the views of FIGS. 1 and 2 for simplicity, the present invention comprehends an apparatus having a pair of identical linkages laterally spaced on the truck frame 14 and each associated with one of the longitudinally extending frame rails 15 typically mounted on the underside of a truck frame for supporting a load thereon. With that understanding, the following discussion will describe the single linkage illustrated in FIG. 1 only.

The linkage 16 includes an L-shaped tilt link 44 pivotally connected to a secondary link 46 near one end thereof by a pivot pin 48. A dump link 50 has one end pivotally connected to the secondary link 46 oppositely of the tilt link 44 by a pivot pin 52. As illustrated in FIG. 2, the dump link 50 extends from a first end 54 adjacent the tilt link 44 along the frame 14 to the rear of the truck to an opposite end 56 which is mounted to the frame 14 with a pivot connection 58.

The tilt link 44 has mutually perpendicular legs 60 and 62. The leg 60 has an outer end 64 terminating in a hook 66 which is rigidly attached to the leg 60 at a pin 68. The hook 66 is engageable with a respective one of the ends 36, 38 of the grab bar 34. The leg 62 is pivoted to the secondary link 46 by the pivot pin 48.

The secondary link 46 is an elongate rigid member having opposed ends 70 and 72. The end 72 includes the pivot 52 which joins the secondary link 46 with the dump link 50 intermediate the ends of the latter. An extendible hydraulic tilt cylinder 74 has its cylinder end 76 pivotally connected to the end 70 of the secondary link 46 and its rod end 78 pivotally connected to the outer end 64 of the tilt link 44 by the pin 68. Thus, the hydraulic cylinder 74 is operable to rotate the tilt link 44 relative to the secondary link 46 between the solid and dotted line positions shown in FIG. 2.

The dump link 50 extends from the pivot 58 at the rear most end 80 of the frame 14 forwardly to its end 54 which is in close proximity to the end 81 of the leg 62 of the tilt link 44.

A hydraulic main power cylinder 82 has its cylinder end 84 pivotally connected by means of a pivot 86 to the frame 14 oppositely of the pivot 58. The rod end 88 of the cylinder 82 is connected at an opposite end 88 by means of pivot 90 to the secondary link 46 intermediate its ends 70 and 72.

As best shown in the enlarged view of FIG. 3, the end 54 of the dump link 50 has a section 92 from which a dump tab 94 having perpendicular surfaces 96 and 98 extends. The leg 62 has a complementary arrangement with an angled section 100 and perpendicular faces 102 and 104 on a tilt tab 106 which extends into underlying relation with the tab 94. Thus, the surface 98 on the tab 94 of the dump link 50 and the surface 104 of the tab 106 on the leg 62 of the tilt link 44 serve as stops and may engage to limit clockwise rotation of the secondary link 46 relative to the dump link about the pivot pin 52 when so engaged. However, when the tilt link 44 is rotated in a clockwise direction relative to both the dump link 50 and the secondary link 46 as seen in FIG. 3, the tabs 94 and 106 disengage. When this occurs, the cylinder 82 may be operated to pivot the secondary link 46 on the dump link 50 without moving the latter on the frame 14.

In one mode of operation, the linkage 16 is adapted for providing on and off loading of a typically constructed refuse receiving body 20.

Prior to entering the on-off loading mode, each of the links 44, 46 and 50 will typically be positioned as shown in solid lines in FIG. 2 such that the linkage forms a generally L-shaped structure extending along the length of the frame 14 and up the rear face 18 of the cab 12. Each of the hydraulic cylinders 74 and 82 initially will be in a retracted position. The tilt cylinder 74 is then extended by any suitable control (not shown) to move the tilt link 44 relative to secondary link 46 and the dump link 50 to the dotted line position shown in FIGS. 2 and 3. This rotation results in disengagement of the tab 106 on the tilt link 44 and the tab 94 on the dump link 50. The main cylinder 82 is then actuated and operates to rotate the secondary link 46 about the pivot 52 as shown in FIG. 4. Because the tilt link 44 and the dump link 50 are disengaged, the tilt link 44 will move with the secondary link 46 while the dump link 50 will remain stationary on the frame 14. The power cylinder 82 is continuously extended to rotate the secondary link 46 and tilt link 44 into position for engaging and hooking the grab bar 34 of a body 24 positioned on the ground or depositing a body. For on loading, once the hook 66 is aligned with the grab bar 34, the power cylinder 82 is retracted to rotate the secondary link 46 in a counter clockwise direction as viewed in FIG. 5 to fully engage the hook 66 with the body 20. Continued rotation of the secondary link 46 results in the raising of body 20 onto the truck 10. Once the secondary link 46 is rotated back into its initial position, the power cylinder 74 is retracted to rotate tilt link 44 about pivot 48 to pull the body forward on the linkage 16 to the position shown in FIG. 1 to be ready for transport. Rollers (not shown) may be conventionally employed to allow ready movement of the body 20 on the truck 10.

To off load the body 20, the above process is simply reversed.

In the dumping mode of operation, the links 44, 46 and 50 are rotated in unison as a rigid structure under power from the power cylinder 82 to elevate a body 20 carried on the frame 14 to an angle sufficient to permit the discharge of material carried within the body through the end wall/door 28 under the force of gravity.

In this mode, the body 20 is elevated and tilted with the linkage 16 in the following manner. With the links 44, 46 and 50 in the configuration shown in FIG. 1 with the tabs 94 and 106 of the tilt link 44 and the dump link 50 engaged, the power cylinder 82 is actuated by any suitable control (not shown). At the same time, the cylinder 74 is locked in its retracted position as by a conventional hydraulic lock in its actuating circuit. As the power cylinder 82 is extended, the rod end 88 exerts an elevating force against the secondary link 46. Due to the pivotal connection 48 between the tilt link 44 and the secondary link 46, and the cylinder 74 being locked in a retracted configuration, the tabs 94 and 106 are engaged to transmit the elevating force to the dump link 50. As a result, the links 44, 46 and 50 move in unison about the pivot 58 on the rear of the truck frame to the position shown in FIG. 5.

Once the linkage 16 is raised to an angle sufficient to allow the gravity-induced discharge of materials contained within the body 20, or prior thereto as desired, the lock pin 42 is withdrawn to permit the rotation of the end wall/door 28 about the hinge axis 40 to permit the egress of material there through. Thereafter, the cylinder 82 may be retracted to lower the linkage to the transport position shown in solid lines in FIG. 2.

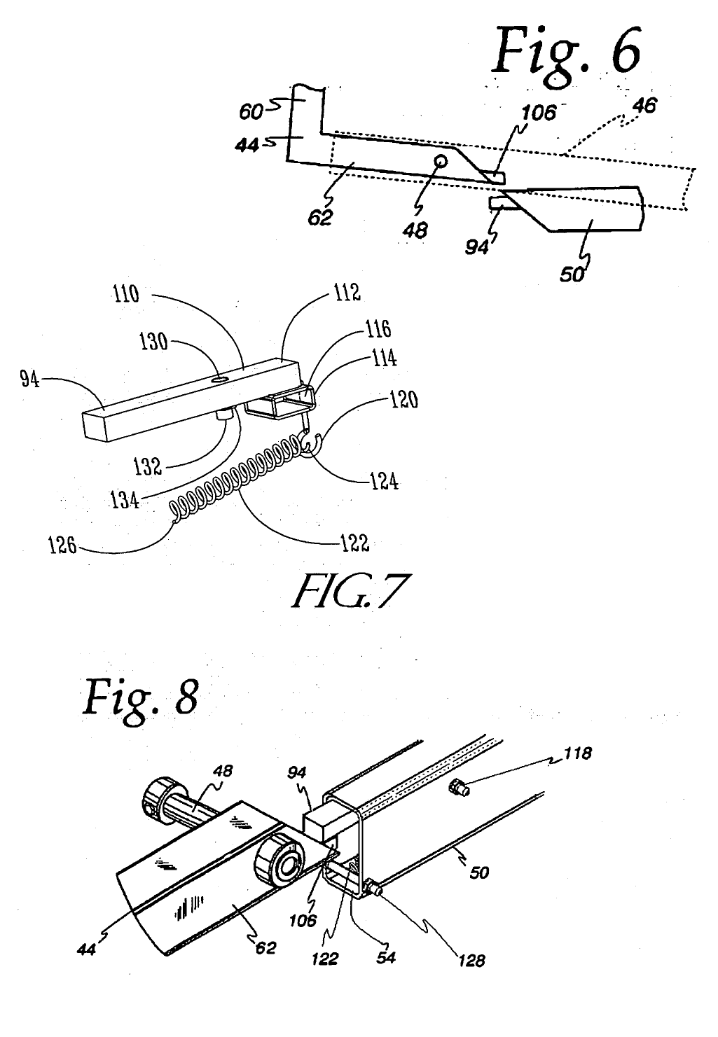

Turning now to FIG. 6, the problem that can occur will be more greatly appreciated with reference thereto. FIG. 6 fragmentarily illustrates the situation where the tilt cylinder 74 (not shown in FIG. 6) has been fully retracted so that the leg 62 of the tilt link 44 is parallel to the secondary link 46. In this situation, the main cylinder 82 (also not shown in FIG. 6) is not fully retracted with the result that the secondary link 46 will be angled somewhat upwardly with respect to the dump link 50. In this case, the tilt tab 106 overlies the dump tab 94. Further retraction of the tilt cylinder 82 will cause the tilt tab 106 to descend and engage the upper surface of the tilt tab 94 before the main cylinder 82 has reached its fully retracted position. As a consequence, continued application of hydraulic pressure to the tilt cylinder 82 will cause an excessive force to be applied to the tabs 94, 106 and such can result in damage to the tilt link 44 and/or the secondary link 46, and possibly the dump link 50 as well.

To avoid this problem, the structure of FIGS. 7 and 8 is incorporated at the interface of the tilt link 44 and the dump link 50.

Referring to FIG. 7, the tab 94 is formed by one end of an elongated metal bar 110. At its end 112 opposite the tab end 94, the bar 110 has a rectangular tube 114 secured thereto as by welding so that an interior 116 of the tube 114 is a right angle to the bar 110. The interior 116 of the tube 114 defines an elongated opening of greater size than a pivot pin formed of a bolt 118 that passes through the dump link 50, which in this case is also formed of a metal tube, at a location spaced somewhat from the end 54 of the dump link. As shown in FIG. 8, the end 54 need not be angled as shown at 92 in FIGS. 3-5, inclusive but may be straight if desired.

In any event, it will be appreciated that by reason of the elongated interior 116 of the tube 114, and the fact that the pivot pin 118 extends through the same, the tab 94 is pivoted to the dump link 50. In addition, because the tube 114 is rectangular, having its long dimension extending parallel to the bar 110, the dump tab 94 is also slidably mounted to the dump link 50 for movement in and out of the dump link 50 as desired.

A hook 120 is attached to the tube 114 at a location opposite the dump tab 94 and outside the interior 116 of the tube 114. A spring 122 having a first end 124 and a second end 126 is attached to the hook 120 at the spring first end 124. The spring second end 126 is attached at the end 54 of the dump link 50 such that the spring 122 is aligned to pull the hook 120 toward the end 54. This pulling also has the effect of pulling the dump tab 94 upward and outward. A spring attachment pin formed of a bolt 128 is located in the end 54 of the dump link 50 opposite the dump tab 94 for attachment of the spring second end in the preferred embodiment.

In the preferred embodiment the hook 120 and the spring ends 124 and 126 are attached by welding, but other attachments are within the scope of the invention. In an alternative embodiment, the spring second end 126 is attached directly to said end 54 and no bolt 128 is present. In another alternative embodiment, the spring first end 124 is attached directly to the tube 114 and no hook is present. It is to be understood that the length of the hook 120, however, is sufficient to transfer pull of the spring 122 to force the dump tab 94 both upward and outward sufficient to normally hold said dump tab 94 against pivotal and slidable movement.

When excess force is exerted on the dump tab 94 greater than the pulling of the spring 122, because of the use of the tube 114 and the elongated opening defined by the interior 116 of the tube 114 provided therein together with the pivot pin 118, the tab 94 may move inwardly or downwardly, or both, within the dump link 50. As can be appreciated by FIG. 6, such movement will allow the dump tab 94 to move out of the path of the tilt tab 106 and permit full retraction of the tilt cylinder 74 without causing damage to any components. In normal operation, where the main cylinder 82 is fully retracted before retraction of the tilt cylinder 74, the tab 106 is free to pass under the tab 94 as can be appreciated from FIG. 3. Thus, so long as the linkage is operated properly, the spring 122 will hold the dump tab 94 in the proper position. In the preferred embodiment the spring 122 is a coil spring but the spring 122 can be substituted with any other type of elastic element having sufficient pull to hold the dump tab 94 in the proper position.

After an improper linkage, the spring 122 will pull the dump tab 94 upward and outward to reset the dump tab 94. At this point, the tilt tab 106 will underlie the dump tab 94 and the entire linkage, whether employed for on-off loading or for dumping, will operate in the manner previously described. Thus, damage that could be expensive or time consuming to repair is easily avoided through the use of the spring 122.

At a location spaced from the tube 114, and thus from the pivot pin 118, a bore 130 (FIG. 7) is located in the bar 110. Sensing means in the form of a sensor 132 extends through the bore 130 to the upper inner surface of the tube forming the dump link 50. A nut 134 is employed to retain the sensor 132 in this position. The sensor 132 senses downward or inward movements or a combination of both movements of the dump tab 94 and thus senses excessive downward force or an excessive sideward force, or a combination of both forces applied to the tab 94. The sensor therefore alerts an operator of improper linkage such that the improper linkage can be disengaged to allow the spring 122 to reset the dump tab 94 and linkage can be re-attempted.

While the invention has been described in terms of pivotally and slidably mounting the tab 94 on the dump link 50, it will be appreciated that the same sort of mechanism could be utilized in mounting the tilt tab 106 to the tilt link 44 provided spatial difficulties do not arise. In the embodiment illustrated, the pivot 48 between the tilt link 44 and the secondary link 46 may hinder such placement but those skilled in the art will readily appreciate that any spatial constraints provided by the presence of the pivot 48 can be avoided simply by repositioning the pivot 48.

1. In a truck frame of a body hauling truck providing on-off loading and dumping modes and including a dump link pivoted to the truck frame, a secondary link pivoted to the dump link, a tilt link pivoted to the secondary link to extend under and up the front of a body, a first extendable dump motor for tilting the secondary link relative to the truck frame, a second extendable motor for pivoting the tilt link relative to the secondary link, and two interengageable tabs separately associated with the tilt link and the dump link to connect said tilt link and said dump link for movement in unison under power from the first extendable motor to effectuate the dumping mode, the improvement comprising:
one tab of said two interengageable tabs, said one tab pivotally and slidably mounted to said link upon which said one tab is associated; and
an element normally holding said one tab against said pivotal and slidable movement, allowing said pivotal and slidable movement when said one tab is subjected to an excess force and returning to normally holding against said pivotal and slidable movement when said one tab is no longer subjected to said excess force.

2. The truck frame of claim 1 wherein said element is an elastic element.

3. The truck frame of claim 2 wherein said elastic element is a spring.

4. The truck frame of claim 3 wherein said spring has a first end and a second end and said link upon which said one tab is associated includes a hook for attaching said spring first end.

5. The truck frame of claim 3 including a pivot pin connecting said one tab to said link upon which said one tab is associated.

6. The truck frame of claim 5 wherein said one tab, at a location remote from the other tab includes an elongated opening of greater size than said pivot pin and said pivot pin extends through said elongated opening.

7. The truck frame of claim 6 wherein said elongated opening is defined by a tube fixed to said one tab at said location.

8. The truck frame of claim 7 wherein said tube is of generally rectangular cross section.

9. The truck frame of claim 7 wherein said spring has a first end and a second end and said link upon which said one tab is mounted includes a hook for attaching said spring first end.

10. The truck frame of claim 7 wherein said dump link includes a spring attachment pin for attachment of said spring second end.

11. The truck frame of claim 1 wherein said one tab includes sensing means for sensing pivotal and slidable movement of said one tab.

12. The truck frame of claim 11 wherein said element is an elastic element.

13. The truck frame of claim 12 wherein said elastic element is a spring.

14. The truck frame of claim 13 wherein said spring has a first end and a second end and said tube includes a hook for attaching said spring first end.

15. In a multi-function linkage in a truck frame for providing on-off loading and dumping of a load-receiving body carried on the truck frame, comprising:
a dump link under the load receiving body and pivoted on the truck frame;
a pair of interconnected links extending about the load receiving body and pivoted to the dump link;
a first actuator for tilting the interconnected links and the dump link relative to the truck frame and for alternatively tilting only the interconnected links relative to the truck frame;
a second actuator for rotating the interconnected links relative to each other; and
engagement means on the dump link for engaging the interconnected links and connecting all of the links for movement in unison under power from the first actuator in the dumping mode and comprising:
two end parts including an end part of the dump link and a complimentary end part of one of the interconnected links;
said end part of the dump link overlaps said complementary end part:
whereby upon rotation of the interconnected links relative to each other under power from the second actuator, the interconnected links are movable relative to the dump link and whereby the interconnected links are movable in unison with the dump link under power from the first actuator, the improvement comprising one of said two end parts, said one of said two end parts connected to its associated link by a pivot and held against pivotal and slidable movement by an elastic element.

16. The truck frame of claim 15 wherein said one of said two end parts includes sensing means for sensing pivotal and slidable movement of said one tab.

17. In a truck frame for a body hauling truck, the combination:
a dump link pivoted at one end to said frame;
an L-shaped tilt link;
a secondary link;
a first pivot connecting said tilt link and said secondary link;
a hydraulic tilt cylinder extending between said tilt link and said secondary link for effecting pivotal movement therebetween;
a second pivot remote from said first pivot and intermediate the ends of said dump link pivotally connecting said secondary link and said dump link; and
a hydraulic main cylinder extending between said frame and said secondary link;
adjacent sections of said tilt link and said dump link being engaged for at least one position of movement of said tilt link to lock said tilt link, said secondary link and said dump link together for movement in unison to provide a dumping mode of operation;
said tilt cylinder being operable to move said tilt link from said at least one position to another position whereat said adjacent sections are not in interference relation thereby freeing said tilt link and said secondary link for pivotal movement relative to said dump link to provide an on-off loading mode of operation;
the improvement comprising one of said adjacent sections of said tilt link and said dump link is movable from said interference relation for another position of movement of said tilt link and back to said interference relation; and
said one adjacent section is mounted to its associated link by a pivotal and sliding connection and is normally held in a position to be in said interference relation by an elastic element.

18. The truck frame of claim 17 wherein said elastic element is a spring.

19. The truck frame of claim 17 wherein said combination includes sensing means mounted in said one adjacent section for sensing pivotal and slidable movement.
